(19) United States
(12) Patent Application Publication
(10) Pub. No.: US 2020/0343501 A1
(43) Pub. Date: Oct. 29, 2020

(54) BATTERY SUPPORT HOUSING

(71) Applicant: Valeo Systemes Thermiques, Le Mesnil Saint Denis (FR)

(72) Inventors: Sergio Da Costa Pito, Le Mesnil Saint Denis (FR); Emmanuel Henon, Le Mesnil Saint Denis (FR); Jean-Nicolas Guyomard, Le Mesnil Fuguet (FR); Emmanuel Rudloff, Le Mesnil Saint-Denis (FR); Guillaume Lair, Le Mesnil Saint Denis (FR)

(73) Assignee: Valeo Systemes Thermiques, Le Mesnil Saint Denis (FR)

(21) Appl. No.: 16/652,498

(22) PCT Filed: Sep. 18, 2018
(86) PCT No.: PCT/FR2018/052282

§ 371 Date: Jul. 15, 2020

(30) Foreign Application Priority Data
Oct. 4, 2017 (FR) 1759271

(51) Int. Cl. H01M 2/10; B60K 1/04

(52) U.S. Cl. CPC H01M 2/1083; B60K 1/04; H01M 2220/20; B60K 2001/0438; H01M 2/1094

(57) ABSTRACT

The invention relates to a battery support housing (1) comprising a cover (2) capable of being attached to the chassis of a vehicle and a support structure (3) capable of receiving an electric battery (B), said support structure (3) being composed of a main face (3a), at least a part of the periphery of which is equipped with a rim (3b), characterized in that at least one zone of the support structure (3) is manufactured by combining a plurality of materials, which materials comprise at least one ductile material, a resistant material and an assembly material.

The present invention relates to a support housing for a battery pack and, more particularly, a support housing for a battery pack for motor vehicles of hybrid type or of electric type. The invention also relates to an assembly comprising such a support housing.

Housings containing electric batteries designed for electric vehicles are known. In general, they comprise a battery, a battery management system, a cover and a lower structure for receiving the battery. More particularly, the lower structure serves as battery support. Said battery is of a considerable weight, a weight that only increases with the development of 100% electric vehicles.

With a view to improving the rigidity of the housing, mention has been made of the use of reinforcement means. These reinforcement means generally have the form of metallic reinforcement bars placed under the housing. However, the battery packs created are particularly heavy and increase consumption by the motor vehicle.

Document US2012103714 proposes, for example, palliating some of these drawbacks by using a lower structure formed from a composite material combining fibers and plastics. However, these materials are still heavy and the costs of manufacturing them are particularly high.

One of the objects of the present invention is to at least in part remedy the prior art drawbacks and to propose a support housing for a battery pack that is light in weight and inexpensive.

To that end, the invention proposes a battery support housing comprising a cover capable of being attached to the chassis of a vehicle and a support structure capable of receiving an electric battery, said support structure comprising a main face, at least a part of the periphery of which is equipped with a rim.

This invention is noteworthy in that at least one zone of the support structure is manufactured by combining a plurality of materials, which materials comprise at least one ductile material, a resistant material and an assembly material.

The housing according to the invention may comprise one or more of the following features, taken alone or in combination:
the resistant material may have a tensile elastic limit greater than 350 MPa;
the resistant material may be a thermoplastic composite material reinforced with glass fibers;
the ductile material may have a tensile elongation capacity greater than 50%;
the ductile material may be a modified polypropylene or an elastomer;
the assembly material may be an injectable plastics material capable of reinforcing said housing and/or of creating interfaces for assembly;
the assembly material may be polypropylene containing glass fibers or propylene containing carbon fibers;
the assembly material may have a modulus of elasticity between 4 GPa and 12 GPa and/or an elastic limit between 70 MPa and 150 MPa;
the main face may be substantially rectangular;
the rim may extend over the entire periphery of the main face;
the rim may be formed by two substantially inclined faces attached via an upper edge parallel to the main face;
the support structure may be composed of a lower skin and an upper skin, said skins delimiting a cavity;
the upper skin may comprise a flange coming into contact with a flange of the lower skin, said flanges being connected to one another in a hermetic manner;
the flanges may be connected by a seal, in particular by an overmolded seal;
the cavity may extend over the entire main face and the rim;
the lower skin may be planar and the upper skin corrugated, which upper skin has lower points in contact with the lower skin and upper points designed to come into contact with the electric battery;
reinforcement elements may be placed in the cavity;
the rim may comprise reinforcement elements;
reinforcement elements may be placed in the region of the main face, between the upper skin and the lower skin;
the support structure comprises three different materials. These three materials are chosen from plastics, polymers and/or elastomers, optionally with glass fibers and/or carbon fibers. In other words, there is no metallic material in the support structure.

Another aspect of the invention is an assembly comprising a housing according to the invention, an electric battery being inserted in the cavity in such a manner as to be held between the support structure and the cover.

According to one example of the invention, a seal may be positioned between the cover and the upper edge of the rim.

Other features and advantages of the invention will become more clearly apparent on reading the following description, which is given by way of illustration and is non-limiting, and the appended drawings, in which:

FIG. 1 shows a schematic representation of an electric vehicle equipped with a support housing according to the invention;

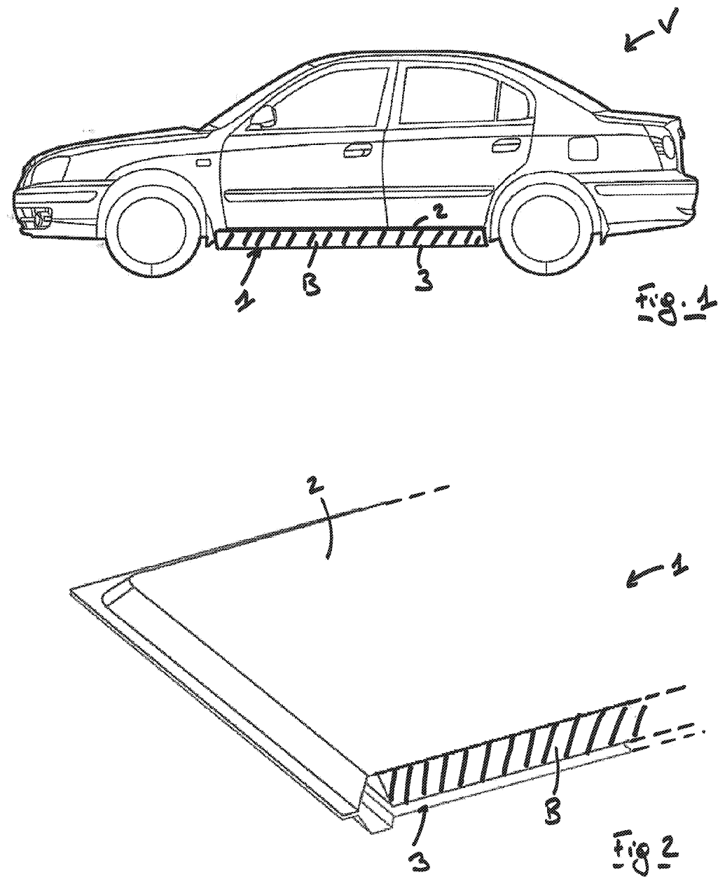

FIG. 2 shows a schematic representation of a portion of the housing of FIG. 1;

FIG. 3 shows a representation of the support structure of the housing of FIG. 2;

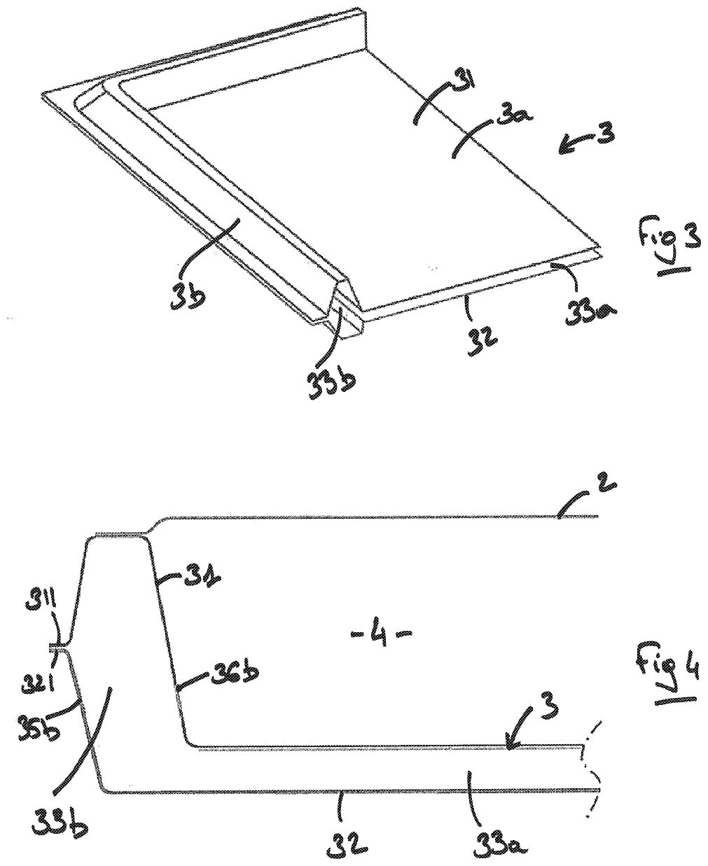

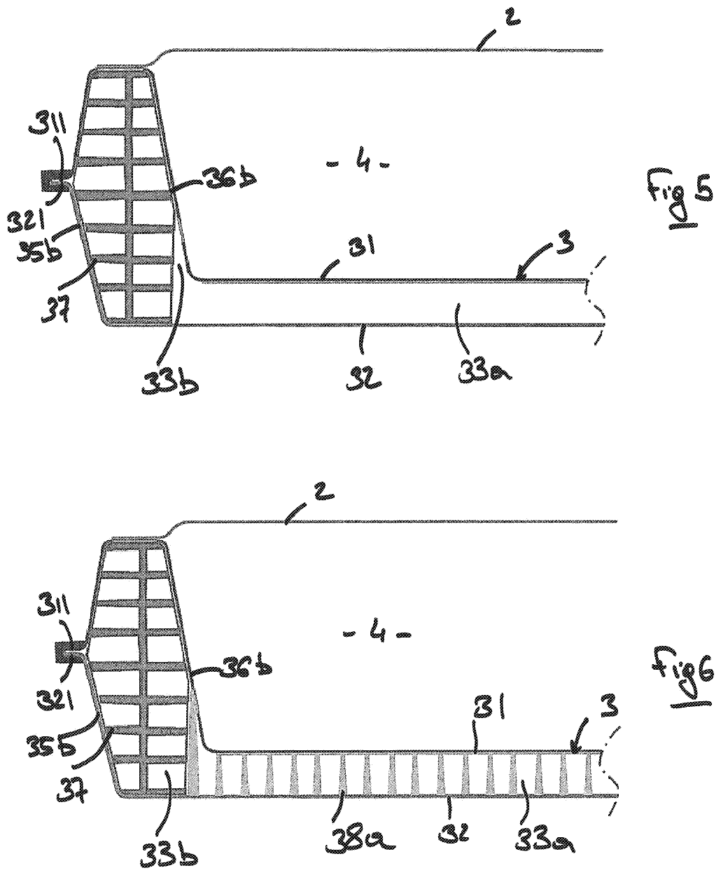

FIG. 4 shows a cross section on AA of the housing of FIG. 2;

FIG. 5 shows a schematic representation of a variant embodiment of the housing of FIG. 4, reinforcement elements being present in the rim of the support structure;

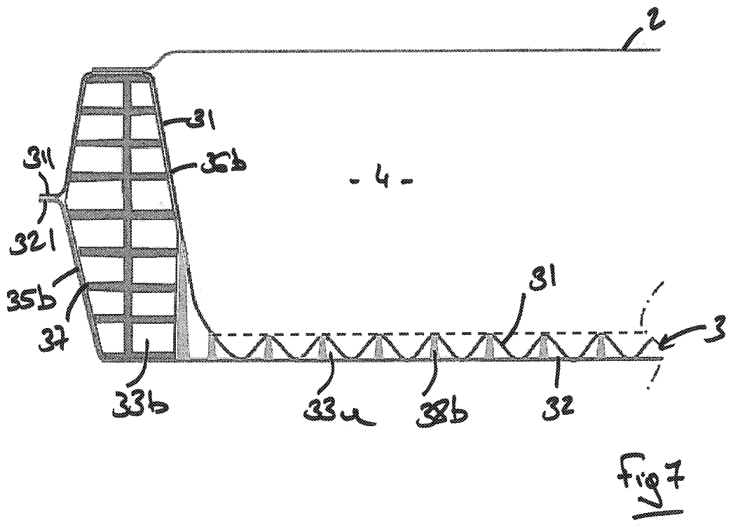

FIG. 6 shows a schematic representation of a variant embodiment of the housing of FIG. 4, reinforcement elements being present in the rim and the main face;

FIG. 7 shows a schematic representation of a variant embodiment of the housing of FIG. 6.

In the various figures, identical elements bear the same reference numbers.

The following embodiments are examples. Although the description relates to one or more embodiments, this does not necessarily mean that each reference relates to the same embodiment or that the features apply only to one embodiment. Simple features of different embodiments may likewise be combined and/or interchanged in order to provide other embodiments.

As illustrated in FIG. 1, electric vehicles V are generally equipped with a battery pack B installed under the vehicle V, and the size of the battery pack B can vary as a function of the requirements of said vehicle V. Said battery is positioned under the chassis and fixed by means of a support housing 1.

A support housing 1 according to the invention is shown in FIG. 2. Said housing comprises a cover 2 and a support structure 3 forming a cavity 4 in which the battery B of the electric vehicle is accommodated. The cover 2 preferably has means for attachment to the chassis of the vehicle. These known attachment means may, for example, be adhesive or, alternately, a threaded-fastener system.

As the cover 2 is not subject to a high level of weight constraints, it may easily be manufactured from any plastics material, thereby making it possible to reduce the overall weight of the vehicle and, as a result, its consumption.

The support structure 3 shown in FIG. 3 likewise has a substantially planar main face 3a. In the appended figures, the main face 3a is shown as being of rectangular form. However, it may have any form fit for the person skilled in the art.

The cover 2 has a form that is substantially the same as that of the main face 3a so as to totally cover the battery placed in the cavity created between the cover 2 and the face 3a.

A rim 3b is present over at least a part of the periphery of the main face 3a, preferably over the entire periphery. This rim 3b and the main face 3a may be made as a single component. However, they may also have the form of two components attached to one another at a subsequent point.

The rim 3b preferably has a substantially flat upper edge 34b on which the cover 2 is placed when the housing 1 is installed on the chassis of the electric vehicle. The rim 3b preferably has two lateral walls 35b, 36b attached via the upper edge 34b. These lateral walls 35b, 36b are preferably vertical (substantially perpendicular to the main face 3a), but they may also be substantially inclined, as shown in the appended figures. This inclination makes it possible to improve the rigidity of the housing 1 and thus allows the heavy loads originating from the battery to be better supported.

In a preferred embodiment, the upper edge 34b is equipped with a seal that makes it possible to close the housing 1 in a leaktight manner so as to avoid any battery malfunction.

In one embodiment (not shown), the support structure 3 is produced as a single layer, which thus allows a considerable saving and can suit batteries of reduced size.

In the appended figures, the support structure 3 has a lower skin 32 and an upper skin 31. These two skins 31, 32 delimit a cavity 33a, 33b. They may have variable thicknesses, depending on the rigidity desired by the user and thus on battery weight. Thinner skins 31, 32 make it possible to reduce the quantity of material used and thus to reduce manufacturing costs. The two skins 31, 32 may form the main face 3a and the rim 3b, or only one of the two components 3a, 3b.

In FIGS. 4, 5, 6 and 7, in the region of the rim 3b, the upper skin 31 has a flange 311 and the lower skin 32 has a flange 321. When the two skins 31, 32 are assembled, the flanges 311, 321 are installed in such a manner as to come into very close contact with one another. A hermetic closure means is then used to close the housing 1 and thereby protect the battery after its installation on the motor vehicle. This hermetic closure means may, for example, be an overmolded seal or, alternately, adhesive.

In a preferred embodiment, the flanges 311, 321 are placed in the region of the exterior lateral wall 35b of the rim 3b, preferably at mid-height on the rim 3b.

The support structure 3 is composed of a plurality of materials allowing better resistance to the stresses exerted and thus making it possible to obtain better load distribution. The applicant has noted that better resistance was obtained when different types of materials were combined.

In a preferred embodiment, the structure 3 is formed by means of processes such as a heat-molding process and/or an injection process.

At least one zone, preferably the entirety, of the support structure 3 is manufactured by combining a ductile material, a resistant material (or a material with a high level of stiffness) and an assembly material. This particular combination of materials makes it possible to withstand the heavy loads and also temperature constraints. Moreover, it makes it possible to better protect the battery against any impacts caused by stones and/or pebbles thrown up during use of the vehicle.

The ductile material, i.e. a material that can withstand a high degree of plastic deformation, preferably has a tensile capacity greater than 50%. This material will make it possible to offset any deformations while preserving the integrity of the housing 1. Such a material is capable of deforming without rupture in the event of impact. In other words, it is capable of deforming in a plastic manner without rupture. This material is preferably a non-reinforced polymer such as, for example, a modified polypropylene or, alternately, any polyamide or polyethylene comprising a certain percentage of elastomers.

The resistant material preferably has a tensile elastic limit greater than 350 MPa. It may, for example, be in the form of a thermoplastic composite material comprising reinforcement fibers. These fibers may, for example, be carbon fibers or, alternately, glass fibers.

The fibers may, in particular, be glass fibers and/or carbon fibers. These fibers may be discontinuous fibers and thus allow manufacture by means of injection. The fibers may be continuous fibers and allow manufacture by heat molding. These manufacturing types are not limiting and it is perfectly possible to imagine any other known manufacturing type. The fibers may be aligned in one direction or in different directions.

The support structure 3 comprises a third material, acting as assembly material, which makes it possible to reinforce said support structure 3 and to create interfaces for assembly. This assembly material is preferably an injectable plastics material. Said assembly material has a modulus of elasticity between 4 GPa and 12 GPa and an elastic limit between 70 MPa and 150 MPa.

In FIGS. 5, 6 and 7, the cavity 33b, created by the two skins 31, 32 in the region of the rim 3b, comprises reinforcement elements 37. These reinforcement elements 37 may, for example, be in the form of ribs or, alternately, in the form of reinforcement bars. These elements 37 make it possible to stiffen the housing 1 and to avoid damaging the battery pack in the event of an accident.

As shown in FIGS. 6 and 7, reinforcement elements 38a, 38b may also lie between the two skins 31, 32 in the region of the main face 3a. These reinforcements 38a, 38b make it possible further to improve the rigidity of the housing 1 and to avoid impacts caused by pebbles and stones from underneath the car.

FIG. 6 shows an embodiment comprising reinforcement elements 38a. These reinforcement elements 38a may, for example, be ribs, studs, bars, etc. They are preferably integrated between the two skins 31, 32. Just as for the remainder of the support structure 3, these elements 38a may be produced by molding or injection at the same time as the housing 1 is created. They may optionally be added subsequently by means of injection.

FIG. 7 shows an embodiment similar to that of FIG. 6, apart from the fact that the upper skin 31 is corrugated. The corrugations created make it possible to create an elastic effect allowing the battery to be held in place better once it has been placed in the housing 1. The reinforcement elements 38b are then placed between the corrugations created by the upper skin 31.

The reinforcement elements 37, 38a, 38b may, for example, be manufactured from plastics material, from composite material or, alternately, from metal. They are preferably produced by means of processes such as an injection process or, alternately, an extrusion process.

Of course, it should be understood, nevertheless, that these exemplary embodiments are provided to illustrate the subject matter of the invention. The invention is not limited to these embodiments described above and provided solely by way of example. It encompasses diverse modifications, alternate forms and other variants that a person skilled in the art will envisage within the scope of the present invention and, in particular, any combination of the various embodiments described above.

1. A battery support housing comprising:
a cover capable of being attached to the chassis of a vehicle; and
a support structure capable of receiving an electric battery, said support structure comprising a main face, at least a part of the periphery of which is equipped with a rim,
wherein the support structure is manufactured by combining a plurality of materials comprising a ductile material, a resistant material and an assembly material.

2. The housing as claimed in claim 1, wherein the resistant material has a tensile elastic limit greater than 350 MPa.

3. The housing as claimed in claim 1, wherein the ductile material has a tensile elongation capacity greater than 50%.

4. The housing as claimed in claim 1, wherein the assembly material is an injectable plastics material capable of reinforcing said housing and/or of creating interfaces for assembly.

5. The housing as claimed in claim 1, wherein the assembly material has a modulus of elasticity between 4 GPa and 12 GPa and/or an elastic limit between 70 MPa and 150 MPa.

6. The housing as claimed in claim 1, wherein the rim is formed by two substantially inclined faces attached via an upper edge parallel to the main face.

7. The housing as claimed in claim 1, wherein the support structure is composed of a lower skin and an upper skin, said skins delimiting a cavity.

8. The housing as claimed in claim 7, wherein the lower skin is planar and the upper skin is corrugated, which upper skin has lower points in contact with the lower skin and upper points designed to come into contact with the electric battery.

9. The housing as claimed in claim 7, wherein reinforcement elements are placed in the cavity.

10. An assembly comprising:
a housing comprising:
a cover capable of being attached to the chassis of a vehicle, and
a support structure capable of receiving an electric battery, said support structure comprising a main face, at least a part of the periphery of which is equipped with a rim,
wherein the support structure is manufactured by combining a plurality of materials comprising a ductile material, a resistant material and an assembly material; and
an electric battery being inserted against the main face in such a manner as to be held between the support structure and the cover.

11. A battery support housing comprising:
a cover capable of being attached to the chassis of a vehicle; and
a support structure capable of receiving an electric battery, said support structure comprising a main face, at least a part of the periphery of which is equipped with a rim,
wherein the support structure comprises three different materials selected from the group consisting of: plastics, polymers and elastomers, at least one zone of the support structure being made by combining the three different materials.
